(19) United States
(12) Patent Application Publication
(10) Pub. No.: US 2018/0370850 A1
(43) Pub. Date: Dec. 27, 2018

(54) METHOD OF SIMULTANEOUSLY COATING AND TEMPERING GLASS AT HIGH TEMPERATURE

(71) Applicants: Solar-Tectic. LLC, Briarcliff Manor, NY (US); Blue Wave Semiconductors, Inc., Baltimore, MD (US)

(72) Inventors: Ashok Chaudhari, Briarcliff Manor, NY (US); Ratnakar D. Vispute, Columbia, MD (US)

(73) Assignees: Solar-Tectic, LLC, Briarcliff Manor, NY (US); Blue Wave Semiconductors, Inc., Baltimore, MD (US)

(21) Appl. No.: 16/047,166

(22) Filed: Jul. 27, 2018

Related U.S. Application Data
(60) Provisional application No. 62/538,555, filed on Jul. 28, 2017.

(51) Int. Cl. C03C 17/34; C03C 17/36

(52) U.S. Cl. CPC C03C 17/3482; C03C 17/3452; C03C 17/3689; C03C 17/3655; C03C 2217/241; C03C 2218/322; C03C 2217/214; C03C 2217/268; C03C 2217/285; C03C 2218/154; C03C 2218/31; C03C 2217/211

(57) ABSTRACT

A method for simultaneously tempering and coating glass, including heating a glass substrate, depositing a textured buffer layer on the glass substrate, depositing a material on the buffer layer, depositing O₂, and rapidly cooling the glass substrate by introducing a gas. This includes coating the glass substrate with crystalline sapphire or a low E film, for example.

This application claims priority to U.S. Provisional Patent Application No. 62/538,555 filed Jul. 27, 2017, entitled “Method of Simultaneously Coating and Tempering Glass at High Temperature” and is hereby incorporated by reference in its entirety.

### BACKGROUND

Two methods for making heat tempered glass include: the off-line method and chemical tempering. The off-line method requires heating the glass to its melting point and then quickly cooling it. This changes the glass and makes it safer. It also creates a hard layer on top of the glass which is an improvement as far as anti-scratch is concerned. Chemical tempering, the other industrial approach to strengthening glass occurs when various chemicals exchange ions on the surface of the glass in order to create compression, Chemical tempering does not have a size limitation (such as 1 mm thickness in heat strengthening), and it costs far more than making tempered glass via the off-line method. This approach nonetheless is used by major glass companies such as Corning and Asahi Glass in their Gorilla Glass and Dragontrail glasses, respectively.

Asahi Glass Company (AGC) takes the following approach with regard to tempering, obtained from their public technical details, and offers a contrast to the present invention. Tempering ovens are used. There are two types: The first type is a continuous furnace where high volumes of a like size are conveyed straight through a long oven and then cooled. There is also a batch type furnace where multiple sizes of the same type of glass are introduced into an oscillating oven for heating. While the output from a batch type furnace is much less, it is preferred for custom tempering. In both cases, the fundamentals of the tempering process are the same. The glass must be heated to the point where the core glass temperature exceeds the softening point. This temperature is 550° C. for most glasses used in the AGC process. After achieving the proper temperature the glass is quenched with high pressure air from both the top and bottom. During quenching a temperature differential is formed between the top and bottom surfaces and the glass core. After quenching the glass goes through controlled cooling in order to prevent the surfaces from reheating. The temperature differential formed during quenching causes the glass surfaces to go into compression and the center to go into tension.

Glass is 4 times stronger in compression. When the compression layer is fractured the core tension shatters the glass and breaks it into small partials sometimes referred to as dice. Safety glass standards ANSI Z97.1-2009 and CPSC 16CFR1201 require that the dice size must be small enough that the 10 largest dice weigh less than the equivalent of 10 in 2 of the original specimen.

There is a difference between heat tempered glass, and heat strengthened glass. Both processes involve heating the glass to high temperature, i.e. its melting point (550° C. to 648° C.), and then force cooling, which creates center tension and surface edge compression. In tempered glass heating, the cooling process is accelerated to create higher surface compression and edge compression in the glass. The compression in tempered glass is at least 10,000 psi. This makes the glass 4-5 times stronger than regular annealed or untreated glass. In heat strengthened glass, the cooling process is slower which means the compression strength is lower. Heat strengthened glass is therefore only twice as strong as annealed or untreated glass. For heat strengthened glass, the requirement is a surface compression of 3,500 to 7,500 psi with no requirement for edge compression. For tempered glass the requirement is a minimum of 10,000 psi and edge compression of at least 9,700 psi.

Tempered glass is a flat glass product which has undergone heat-treatment, heating the glass to approximately 1,112° F. (600° C.), then rapidly cooling the glass. This rapid cooling locks the surface of the glass in a state of compression. This makes it more resistant to mechanical and thermal stresses and gives it the required fragmentation characteristics.

One drawback of the heat strengthening processes described above, is that it is limited to glasses with a minimum thickness of about 1 mm, so that these methods cannot be employed for thin glasses that have a thickness of less than 1 mm. However, in particular in the touch display sector there is a great demand for very thin toughened glasses.

Most of the glass produced by Asahi Glass Company, for example, can be tempered: Energy Select, Comfort Select and Stopray Vision low-emissivity glass is also available post-tempered.

Annealed Glass

It is useful to distinguish the present invention from common annealed glass. Annealing of glass is a process of slowly cooling hot glass objects after they have been formed, to relieve residual internal stresses introduced during manufacture. Especially for smaller, simpler objects, annealing may be incidental to the process of manufacture, but in larger or more complex products it commonly demands a special process of annealing in a temperature-controlled kiln known as a lehr. Annealing of glass is critical to its durability. Glass that has not been properly annealed retains thermal stresses caused by quenching, which indefinitely decrease the strength and reliability of the product. Inadequately annealed glass is likely to crack or shatter when subjected to relatively small temperature changes or to mechanical shock or stress. It even may fail spontaneously.

To anneal glass, it is necessary to heat it to its annealing temperature, at which its viscosity, η, drops to 1013 Poise (“Poise” is a measure of absolute viscosity; 1 poise=1 dyne-second/cm²). For most kinds of glass, this annealing temperature is in the range of 454-482° C., and is the so-called stress-relief point or annealing point of the glass.

At such a viscosity, the glass still is too hard for significant external deformation without breaking, but it is soft enough to relax internal strains by microscopic flow in response to the intense stresses they introduce internally.

The present invention differs from this annealing in two important ways: 1) the glass is heated much higher than the annealing temperature of 454-482° C. and 2) in the present invention the glass heated has already been annealed.

The question may be raised, why not use tempered glass and deposit the crystalline (sapphire or ceramic of low E material) coating on that glass? The answer is simply that reheating the tempered glass ruins it. The same applies to chemically strengthened glass.

Recent prior art by Schott Glass AG in US publication 2017/0210662, provides an alternative method of strengthening a thin sheet of glass (in the form of a glass laminate), even below 100 μm (microns). This differs from the present invention, for example, in the Schott AG invention the laminate comprises a composite of at least three layers of glasses, each with different properties, and the method of making the laminate consisting of these layers is much more involved than the present invention. The present invention offers a simple process, improving upon and modifying an evaporation process disclosed in U.S. Pat. No. 9,719,165, by Vispute and Chaudhari, hereby incorporated by reference herein.

### SUMMARY OF THE INVENTION

In the patent application Ser. No. 14/146,465 by Praveen Chaudhari and Ser. Nos. 15/469,962 and 15/470,161 by A. Chaudhari and RD Vispute, incorporated by reference to their entirety herein, technology is disclosed for growing hard crystalline thin-film coatings such as sapphire on ordinary soda-lime glass. The growth temperature of these films is exactly in the regime of the melting point of glass. The method of the present invention provides simultaneously tempering and/or strengthening the glass and growing a hard coating (glass tempering requires heating glass to its melting point) Such a process not only provides an efficient way of making glass that is hard, scratch proof, and safe, but also low emissivity glass (low E glass). Moreover, it also solves problems that can arise when coatings are deposited on soda-lime glass at high temperature: namely, 1) the weakening of the soda-lime glass and 2) the cracking of coatings such as low E films. By tempering the glass and coating simultaneously, this first problem is solved. And the second problem is solved because the low E coating can be applied without reheating the glass, which ruins uniformity and causes cracking in the low E coating.

Historically, there have been two ways to apply coatings to glass. During the “online” Chemical Vapor Deposition (CVD) process, also known as “pyrolytic coatings”, the coating is applied during float glass production. The “off-line” process occurs after the float glass is produced, using a Magnetron Sputter Vacuum Deposition (MSVD) coater, commonly known as “sputtered coatings”. Our process is different from these because we add the coating while the glass is heated in the chamber. The glass has already been made (unlike the on-line process) and the glass is at a very high temperature (550 C) when the coating is applied, unlike the “off-line” process.

One main advantage of tempered glass, and an important aspect of the present invention, is that if broken, tempered glass fragments into small pebble-sized pieces, limiting the risk of personal injury. Tempered glass is considered a safety glass and can be used in applications that require safety glazing such a doors and shower enclosures—just to name a few.

The present invention provides a method for simultaneously tempering and coating glass, including heating a glass substrate, depositing a textured buffer layer on the glass substrate, depositing a ceramic material on the buffer layer, depositing O₂, and rapidly cooling the glass substrate by introducing a gas. The method as recited in claim 1, wherein the buffer layer is MgO.

The present invention also provides a method for tempering and coating glass with a low E film, including heating a glass substrate, depositing a textured buffer layer on the glass substrate, depositing tin on the buffer layer, forming a tin oxide film, doping the tin oxide film with fluorine, and rapidly cooling the glass substrate by a gas.

The present invention also provides a method for simultaneously strengthening and coating glass with sapphire, including heating a glass substrate, depositing a textured buffer layer on the glass substrate, depositing an aluminum source and O₂, forming a Al₂O₃ film, and allowing the substrate to cool naturally.

The present invention also provides a method for simultaneously tempering and coating glass, including heating a glass substrate, depositing a photovoltaic absorber coating on the glass substrate, depositing a conducting layer, and rapidly cooling the glass substrate by introducing a gas.

An object of the present invention is to provide a method for tempering and strengthening glass while simultaneously coating the glass.

Another object of the present invention is to provide a method of tempering and strengthening very thin glass.

Another object of the present invention is to provide a method of tempering and strengthening the coating.

Another object of the present invention is to provide a method of depositing a crystalline coating on glass without weakening the glass.

Another object of the present invention to provide a method of depositing low-e coatings on glass.

It is yet another object of the present invention to provide a method of depositing coatings (anti-scratch and low-e) in a simple and elegant way.

### BRIEF DESCRIPTION OF DRAWINGS

FIG. 1 shows a thin glass sheet with coatings of MgO and Al₂O₃; and

FIG. 2 shows a thin glass sheet with coatings of MgO and Al₂O₃ in an electron beam evaporation chamber.

### DETAILED DESCRIPTION

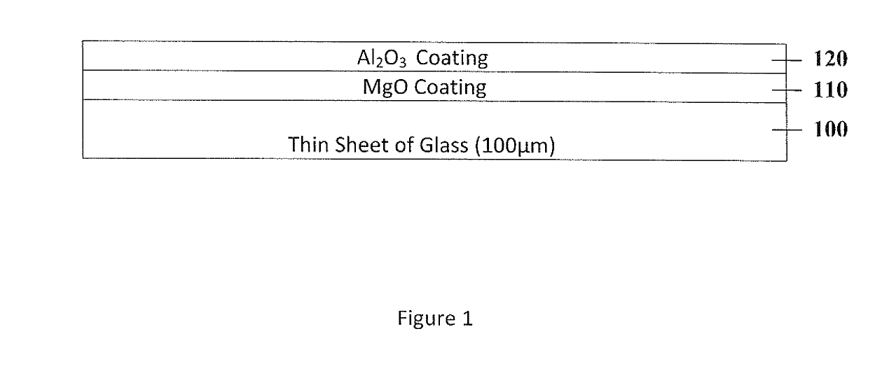

FIG. 1 shows a thin sheet of glass 100 having MgO coating 110 and a Al₂O₃ coating 120. Thin glass sheet 100 is 100 μm.

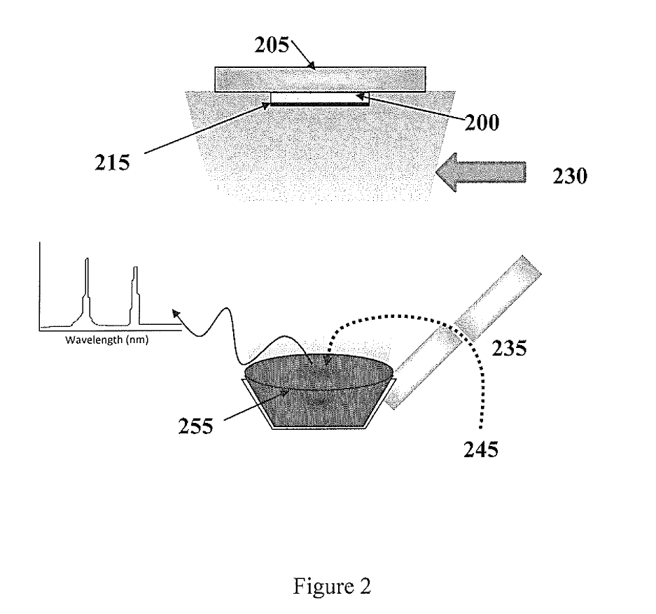

FIG. 2 shows an electron beam evaporation chamber 225. Chamber 225 has substrate holder 205, focusing coils 235, e-beam source 245 and target 255. Substrate holder 205 holds thin sheets of glass 200. Focusing coils 235 direct e-beam source 245 to target 255. Target 255 first holds highly dense MgO and then Al₂O₃ crystals or just Al if O₂ is added to make Al₂O₃ (this target can be any ceramic material). A crystalline MgO layer 215 is first deposited at 550° C. and then a sapphire (Al₂O₃) layer 215 is deposited at 550° C. or slightly above, which is also the melting temperature of the glass. Glass 200 with coating 215 is then cooled rapidly by introducing O₂ 230 into chamber 225. 1 atm of O₂ is added. After the cooling from O₂, glass 200 has simultaneously been strengthened and tempered and also has a hard coating. Not only does this cooling temper the glass, but it also tempers Al₂O₃ and MgO layers 215 which increases their hardness. The coatings may be directly deposited on one another and the substrate or may have layers in between. This embodiment includes 2 layers, however, the number of layers is not limited, and multiple layers are possible.

In a second embodiment, pre-tempered glass is used as the glass substrate on which to deposit the crystalline film coating. The tempered glass, available from say Asahi Glass Company, is put in the chamber and heated to the required deposition temperature for the crystalline coating to be deposited, say 550° C. O₂ is then introduced and like in FIG. 2, the glass with coating is rapidly cooled. Although by heating the already tempered glass to 550° C. the glass becomes un-tempered, or ruined, by rapidly cooling again the glass regains its temper. Although the tempered glass has a hardened surface already, this only helps to improve the overall hardness of the sapphire coating.

It should be noted that in the present invention, various ceramic materials can be used instead of sapphire and MgO, following the patents and applications by Vispute and Chaudhari. Also, in addition to O₂, other gases can be used, which may also lower the temperature quickly, without negatively influencing the materials. In fact, some gases may not only serve to rapidly lower the temperature, but might also have additional benefits, such as allowing for low E emissivity, or Anti-Reflection Coatings, or doping, or coloring.

It should be noted that the cooling process disclosed in the present invention is sharply different than the process(es) currently used in the industry described above, which involves high-pressure air blasts on the surface of the glass from an array of nozzles in varying positions.

In the present invention, the cooling of the glass with coating can take place in various ranges. For example, the glass substrate could be heated to 500° C., 550° C., or 600° C. or 650° C. Also, the cooling of the glass can take place in various ranges and at various speeds. For example, the glass could be cooled from 550° C. to 500° C. in under 1 minute. Or it can be cooled from 550° C. to 400° C. in under 1 minute. And so forth. It is understood that each range and cooling rate will have a certain outcome that may be desirable.

In the present invention, the tempering of the glass as well as crystalline film growth can take place with glass of various thicknesses. For example, tempering can take place with very thin glass of say 0.7 mm (700 microns), an even thinner glass, 100 microns. thicker glass, 10 mm. or even thicker glass, 100 mm. While the present invention is mostly concerned with soda-lime glass, because it is the least expensive of all glasses, there may be other glasses that are desirable, for example, borosilicate, or quartz.

In one variation of the present invention, rapid cooling of the tempered glass is not necessary because the crystalline film coating replaces the hard top layer which is brought about by the rapid cooling. This means that once the glass is heated to the melting point, the temperature just needs to be lowered slightly, and the coating then deposited. So in one exemplary iteration the steps are: 1) heating the soda-lime glass to 575° C., where the glass begins to melt, 2) cooling the temperature to 550° C., 3) depositing a crystalline film, and cooling the glass naturally, i.e. it does not require rapid cooling. This process may have a strengthening effect, rather than tempering.

To be clear, a central distinguishing feature of the present invention is the introduction of gas into the vacuum chamber (e-beam or sputtering) to cause cooling. The gas may be O₂, Ar, or Helium, for example.

Thermal Impact

Tempered glass is often used because of its advantageous thermal properties. Regular annealed glass without tempering is easily broken by mechanical stress, impact, and moderate thermal stress. With a ceramic materials as coatings, for example sapphire and MgO, the thermal properties may be greatly enhanced.

Low E Glass

Emissivity is the ability of a material to radiate energy. When heat or light energy, typically from the sun or HVAC system, is absorbed by glass it is either shifted away by air movement or re-radiated by the glass surface.

The glass industry produces a glass product with low emissivity, known a “low E glass.” The process, which involves the deposition of very thin film coatings on glass is a product with some similarity to the present invention with regard to manufacturing. The low E coatings can be deposited in a vacuum chamber using sputtering for example.

In the low E glass manufacturing process, the flat glass (soda-lime) is transferred to a vacuum chamber where the needed coating layers, such as SnO₂:F, are deposited on to the glass surface by sputtering in controlled circumstances (vacuum, gas, layer, thickness). However, this method is sharply different from the present invention because not only does the glass temperature always remain below 100° C., but the method does not allow the glass to be re-heated in order to temper it after the coating process. If the glass is re-heated up to the tempering temperature (from 550° C. to 650° C.), the different thermal expansions of the coating and the glass can make the thin layers crack.

In one embodiment of the present invention, rather than Al₂O₃, low E coatings are deposited on the textured MgO.

The present invention can be applied to low E coating with significant advantage because it allows for the heating of the glass to high temperature for tempering without ruining the uniformity of the low-E films and causing cracking. The textured MgO buffer layer, or many other types of potential buffer layers such as oxides or nitrides, keeps these low E coatings from cracking by minimizing the thermal expansion effect and enhancing the crystallinity of the films. Moreover, can also help with the light transmission of the low E glass. For example, in many low-E glass products light transmission is 81% or less. In the present invention 89% can be achieved, providing a dramatic improvement.

The low E coatings, for example Indium Tin Oxide (ITO) can vary in thicknesses, for example 1-10 nm, 10-20 nm, 20-30 nm, 1 um, 5 um or 20 um.

Thus, the present invention also allows for the simultaneous growth of low E coatings and tempering. In fact, it allows for the simultaneous growth of an unlimited number of coatings, and tempering. The textured buffer layer, say MgO, induces texture in the low E film, and this in turn allows the low E glass product to be used as a substrate for semiconductor film growth, where the semiconductor films also gain texture, providing a whole new application of the low E glass product.

Finally, the present invention can also be applied to transparent photovoltaic glass (TPV) products, where a tempered or strengthen glass substrate is advantageous. For example, in building integrated photovoltaics (BIPV). In this case, the photovoltaic (PV) absorber coatings, along with conducting layers such as ITO, when applied in an electron beam evaporation chamber, can be grown on glass that is simultaneously tempered or strengthened for BIPV purposes in a similar fashion as discussed above.

The present invention can be carried out using various common PVD (physical vapor deposition) processes, such as electron beam evaporation (e-beam) or sputtering.

### EXAMPLES OF THE INVENTION

### Example 1—Tempered Glass with Sapphire Coating

Electron-beam evaporation was used for the growth of tempered sapphire glass, consisting of a thin layer of MgO on soda-lime glass, followed by a thin film of Al₂O₃ grown on top. The evaporator consists of a stainless steel high vacuum chamber capable of reaching 10E-7 Torr with the help of a cryopump. Initial rough vacuum up to 10-3 Torr was achieved with a mechanical dry pump. Prior to vacuuming the chamber, batches of initial soda-lime glass substrates were loaded on a substrate heater that is capable of controlling temperature of the substrates while growing the MgO buffer layer and sapphire layer in reactive deposition mode. A typical buffer layer of MgO was grown from stoichiometric MgO source material. The presence of background pressure of O₂ (˜10E-4 Torr using O₂ flow need valve)) helps high quality stoichiometric MgO depositions. Substrate temperature was controlled from 300° C. to 650° C. temperature range to control the preferred orientation of the MgO films. Required growth temperature was set using a substrate heater with a typical ramp rate ranging from 15° C./min to 45° C./min. At this stage the system is ready for deposition of the first layer that is MgO. E-beam parameters such as high voltage and emission current were set so that the appropriate evaporation rate of MgO can be achieved. The high voltage (HV approximately 8 KV) for electron beam was setup through potentiometer of the e-beam evaporator system. A good range for setting the bias for Telemark sources is between 17 to 20 A. The electron beam sweep pattern settings can also be judged and finalized without affecting the material. The e-beam system also has joystick that can directly control the e-beam output position, allowing the precondition of the material manually. Once high voltage and emission current is set with desirable evaporation rate of MgO, deposition was conducted for 1 to 2 hours depending upon the film thickness requirement. Studies show varied film thickness of MgO films from a few microns to 7 microns is possible. After MgO deposition, a high purity aluminum (99.999) source was switched for deposition. Initially, the Al source was heated by e-beam to melt the source and the e-beam was adjusted for evaporation of aluminum. Partial pressure was adjusted from 10-4 Torr to 10-6 Torr in order to control reaction of the Al with O₂ on the substrate. Note that the arrival rate of O₂ is adjusted in a way that Al surface mobility can be as high as possible to allow surface migration and then reaction with oxygen so that crystalline properties, grain size, surface smoothness, optical transparency, and interface reaction can be controlled. Thus optimization of aluminum oxide (Al₂O₃) growth includes arrival rates of oxygen background reactive gas atoms and e-beam evaporated aluminum in such a way that aluminum has optimum surface migration for crystallinity and grain size control and reaction with oxygen to form crystalline sapphire (Al₂O₃) or sapphire glass. After the Al₂O₃ film growth is complete the glass substrate must be cooled rapidly to induce tempering in the glass. This is achieved by introducing O₂ into the chamber. The amount of O₂ is 1 atm. (from vacuum to 1 atm.). After cooling, the glass is removed from the chamber. The glass is now both coated with sapphire and tempered.

### Example 2—Tempered Low E Glass

Electron-beam evaporation was used for the growth of tempered low E glass, consisting of a thin layer of MgO on soda-lime glass, followed by a thin film of Flourine doped Tin Oxide (FTO) grown on top. The evaporator consists of a stainless steel high vacuum chamber capable of reaching 10E-7 Torr with the help of a cryopump. Initial rough vacuum up to 10-3 Torr was achieved with a mechanical dry pump. Prior to vacuuming the chamber, batches of initial soda-lime glass substrates were loaded on a substrate heater that is capable of controlling temperature of the substrates while growing the MgO buffer layer and sapphire layer in reactive deposition mode. A typical buffer layer of MgO was grown from stoichiometric MgO source material. The presence of background pressure of O2 (˜10E-4 Torr using O2 flow need valve)) helps high quality stoichiometric MgO depositions. Substrate temperature was controlled from 300° C. to 650° C. temperature range to control the preferred orientation of the MgO films. Required growth temperature was set using a substrate heater with a typical ramp rate ranging from 15° C./min to 45° C./min. At this stage the system is ready for deposition of the first layer that is MgO. E-beam parameters such as high voltage and emission current were set so that the appropriate evaporation rate of MgO can be achieved. The high voltage (HV approximately 8 KV) for electron beam was setup through potentiometer of the e-beam evaporator system. A good range for setting the bias for Telemark sources is between 17 to 20 A. The electron beam sweep pattern settings can also be judged and finalized without affecting the material. The e-beam system also has joystick that can directly control the e-beam output position, allowing the precondition of the material manually. Once high voltage and emission current is set with desirable evaporation rate of MgO, deposition was conducted for 1 to 2 hours depending upon the film thickness requirement. Studies show varied film thickness of MgO films from a few microns to 7 microns is possible. After MgO deposition, a high purity tin (99.999) source was switched for deposition. Initially, the Sn source was heated by e-beam to melt the source and the e-beam was adjusted for evaporation of tin. Partial pressure was adjusted from 10-4 Torr to 10-6 Torr in order to control reaction of the Sn with O₂ on the substrate. Note that the arrival rate of O₂ is adjusted in a way that Sn surface mobility can be as high as possible to allow surface migration and then reaction with oxygen so that crystalline properties, grain size, surface smoothness, optical transparency, and interface reaction can be controlled. Thus optimization of tin oxide growth includes arrival rates of oxygen background reactive gas atoms and e-beam evaporated aluminum in such a way that aluminum has optimum surface migration for crystallinity and grain size control and reaction with oxygen to form crystalline tin oxide. After the tin oxide film growth is complete, it is doped with fluorine which is introduced to the chamber. Finally, the substrate must be cooled rapidly to induce tempering in the glass. This is achieved by introducing O₂ into the chamber. The amount of O₂ is 1 atm. (from vacuum to 1 atm.). After cooling, the glass is removed from the chamber. The glass is now coated with a textured FTO low E coating, and tempered.

### Example 3—Strengthened Glass with Sapphire Coating

Electron-beam evaporation was used for the growth of tempered sapphire glass, consisting of a thin layer of MgO on soda-lime glass, followed by a thin film of Al₂O₃ grown on top. The evaporator consists of a stainless steel high vacuum chamber capable of reaching 10E-7 Torr with the help of a cryopump. Initial rough vacuum up to 10-3 Torr was achieved with a mechanical dry pump. Prior to vacuuming the chamber, batches of initial soda-lime glass substrates were loaded on a substrate heater that is capable of controlling temperature of the substrates while growing the MgO buffer layer and sapphire layer in reactive deposition mode. A typical buffer layer of MgO was grown from stoichiometric MgO source material. The presence of background pressure of O₂ (˜10E-4 Torr using O₂ flow need valve)) helps high quality stoichiometric MgO depositions. Substrate temperature was controlled from 300° C. to 650° C. temperature range to control the preferred orientation of the MgO films. Required growth temperature was set using a substrate heater with a typical ramp rate ranging from 15° C./min to 45° C./min. At this stage the system is ready for deposition of the first layer that is MgO. E-beam parameters such as high voltage and emission current were set so that the appropriate evaporation rate of MgO can be achieved. The high voltage (HV approximately 8 KV) for electron beam was setup through potentiometer of the e-beam evaporator system. A good range for setting the bias for Telemark sources is between 17 to 20 A. The electron beam sweep pattern settings can also be judged and finalized without affecting the material. The e-beam system also has joystick that can directly control the e-beam output position, allowing the precondition of the material manually. Once high voltage and emission current is set with desirable evaporation rate of MgO, deposition was conducted for 1 to 2 hours depending upon the film thickness requirement. Studies show varied film thickness of MgO films from a few microns to 7 microns is possible. After MgO deposition, a high purity aluminum (99.999) source was switched for deposition. Initially, the Al source was heated by e-beam to melt the source and the e-beam was adjusted for evaporation of aluminum. Partial pressure was adjusted from 10-4 Torr to 10-6 Torr in order to control reaction of the Al with O₂ on the substrate. Note that the arrival rate of O₂ is adjusted in a way that Al surface mobility can be as high as possible to allow surface migration and then reaction with oxygen so that crystalline properties, grain size, surface smoothness, optical transparency, and interface reaction can be controlled. Thus optimization of aluminum oxide (Al₂O₃) growth includes arrival rates of oxygen background reactive gas atoms and e-beam evaporated aluminum in such a way that aluminum has optimum surface migration for crystallinity and grain size control and reaction with oxygen to form crystalline sapphire (Al₂O₃) or sapphire glass. After the Al₂O₃ film growth is complete the glass substrate, in contrast to the previous example, does not need to be cooled rapidly to strengthen the glass. This is achieved by simply allowing the samples(s) to cool in the chamber. Mohs scratch testing of the glass (uncoated side) showed a Mohs 7, which is significant improvement in strength given that Mohs for soda-lime glass is normally 5.5 to 6.5.

In the present invention, the term ‘textured’ has the following meaning: ‘textured’ means that the crystals in the film have preferential orientation either out-of-plane or in-plane or both. For example, in the present invention the films could be highly oriented out-of-plane, along the c-axis.

Although the present invention has been described in conjunction with specific embodiments, those of ordinary skill in the art will appreciate the modifications and variations that can be made without departing from the scope and the spirit of the present invention.

1. A method of simultaneously tempering and coating glass, comprising:
heating a glass substrate;
depositing a textured buffer layer on the glass substrate;
depositing a ceramic material on the buffer layer;
depositing O₂; and
rapidly cooling the glass substrate by introducing a gas.

2. The method as recited in claim 1, wherein the buffer layer is MgO.

3. The method as recited in claim 1 wherein the ceramic material is aluminum, the aluminum forming a thin film of Al₂O₃ with the deposited O₂.

4. A method of tempering and coating glass with a low E film, comprising:
heating a glass substrate;
depositing a textured buffer layer on the glass substrate;
depositing tin on the buffer layer, forming a tin oxide film;
doping the tin oxide film with fluorine; and
rapidly cooling the glass substrate by a gas.

5. A method of simultaneously tempering and coating glass, comprising:
heating a glass substrate;
depositing a photovoltaic absorber coating on the glass substrate;
depositing a conducting layer; and
rapidly cooling the glass substrate by introducing a gas.

6. The method as recited in claim 1 wherein the gas is O₂, He, H₂, Ar, or N₂.

7. The method as recited in claim 4 wherein the gas is O₂, He, H₂, Ar, or N₂.

8. The method as recited in claim 5 wherein the gas is O₂, He, H₂, Ar, or N₂.
